(19) United States
(12) Patent Application Publication
(10) Pub. No.: US 2014/0272841 A1
(43) Pub. Date: Sep. 18, 2014

(54) METHODS FOR RESOLVING AN ISSUE AND BLINDLY RESOLVING AN ISSUE

(71) Applicant: FIRST PRINCIPLES, INC., Albany, NY (US)

(72) Inventor: Keith A. Raniere, Clifton Park, NY (US)

(73) Assignee: FIRST PRINCIPLES, INC., ALBANY, NY (US)

(21) Appl. No.: 13/839,692

(22) Filed: Mar. 15, 2013

(51) Int. Cl. G09B 19/00

(52) U.S. Cl. CPC G09B 19/00
USPC 434/236

(57) ABSTRACT

A method for resolving an issue and a method for blindly resolving an issue are provided. A method for resolving an issue, comprising: (a) providing a group, wherein the group includes at least three Mentors and a Focus; (b) evaluating the Focus by the at least three Mentors; (c) identifying an inconsistent internal existence of the Focus by the at least three Mentors; (d) comparing the inconsistent internal existence to a matrix of consistent internal existence by the at least three Mentors; (e) providing feedback to the Focus from the Mentors; and (f) incorporating the feedback by the Focus to create a modified internal existence of the Focus is provided. A method for blindly resolving an issue is also provided.

### BACKGROUND OF THE TECHNOLOGY

The present invention relates to a method for resolving an issue and a method for blindly resolving an issue.

### RELATED ART

Heretofore, there has been interest towards reconciling personal issues through the use of life coaches, personal counseling, self help materials, therapy, and meditation. Some problems associated with the above methods include lack of objectivity of the administrators, issues of communication, lack of flexibility toward clients, steep learning curves, confidentiality, inability to resolve certain issues, and efficacy of the above methods. Current methodologies have many shortcomings in their resolution of issues. Therefore, a need exists for methods to resolve issues.

### SUMMARY

Methods for resolving issues and exploring the human potential are provided. An aspect of the present invention is a method for resolving an issue, comprising: a) providing a group, wherein the group includes at least three Mentors and a Focus; b) evaluating the Focus by the at least three Mentors; c) identifying an inconsistent internal existence of the Focus by the at least three Mentors; d) comparing the inconsistent internal existence to a matrix of consistent internal existence by the at least three Mentors; e) providing feedback to the Focus from the Mentors; and f) incorporating the feedback by the Focus to create a modified internal existence of the Focus. An additional aspect of the present invention is a method for blindly resolving an issue, comprising: a) providing a group, wherein the group includes at least three Mentors and a Focus; b) blinding the group, wherein the at least three Mentors are blind as to the Focus; c) evaluating the Focus by the at least three Mentors; d) identifying an inconsistent internal existence of the Focus by the at least three Mentors; e) comparing the inconsistent internal existence to a matrix of consistent internal existence by the at least three Mentors; f) providing feedback to the Focus from the Mentors; and g) incorporating the feedback by the Focus to create a modified internal existence.

### BRIEF DESCRIPTION OF THE DRAWINGS

The features of the present invention will best be understood from a detailed description of the invention and an embodiment thereof selected for the purpose of illustration and shown in the accompanying drawing in which:

FIG. 1 illustrates a flow chart of a method for resolving an issue.

FIG. 2 illustrates a flow chart of a method for resolving an issue with reiteration.

FIG. 3 illustrates a flow chart of a method for resolving an issue with reiteration and a plurality of groups, after transforming a previous group into a subsequent group.

FIG. 4 illustrates a flow chart of the transformation from a previous group to a subsequent group in the method for resolving an issue.

FIG. 5 illustrates a flow chart of a method for blindly resolving an issue.

FIG. 6 illustrates a flow chart of a method for blindly resolving an issue with reiteration

FIG. 7 illustrates a flow chart of a method for blindly resolving an issue with reiteration using a plurality of groups.

FIG. 8 illustrates a flow chart of the transformation from a previous group to a subsequent group in the method for blindly resolving an issue.

### DETAILED DESCRIPTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc. . . . , and are disclosed simply as illustrative examples of the various embodiments. The features and advantages of the present invention are illustrated in detail in the accompanying drawings, wherein like reference numerals refer to like elements throughout the drawings. Although the drawings are intended to illustrate the present invention, the drawings are not necessarily drawn to scale.

FIG. 1 represents a flow chart depicting a method for resolving an issue 100. This method for resolving an issue 100 comprises: (a) providing a group 110, wherein the group includes at least three Mentors and a Focus; (b) evaluating the Focus by the at least three Mentors 120; (c) identifying an inconsistent internal existence of the Focus by the at least three Mentors 130; (d) comparing the inconsistent internal existence to a matrix of consistent internal existence by the at least three Mentors 140; (e) providing feedback to the Focus from the Mentors 150; and (f) incorporating the feedback by the Focus to create a modified internal existence of the Focus 160. Each of the steps of this embodiment is discussed in detail in the paragraphs below.

The method comprises (a) providing a group, wherein the group includes at least three Mentors and a Focus 110. A group as used herein may be a number of individuals or computer databases having responses that would have or simulate a particular human personality trait, gender, and age.

An individual as used herein is a human. An individual may have derived information, facts, theories, hypotheses, memories, and experiences from their day to day encounters, interactions, and occurrences. Such information, facts, theories, hypotheses, memories, and experiences may interact with each individual's strengths, weaknesses, temperament, physical, mental, and emotional characteristics to derive a particular human personality trait. Similarly, computers may be used to portray human personality traits. For example, computers may be equipped with artificial intelligence to synthesize certain emotional-type tendencies and likelihoods. As another example, a computer may be programmed such that, through the completion of various processes, operations, or algorithms, an individual's personality trait, age, and gender may be computer-simulated and articulated as any individual may indicate or articulate their personality traits, age, or gender to others. Referring to a group herein may refer to the individuals, computer databases, or a combination of both that may be gathered, assembled, or recognized as together to comprise the present method.

Each group may contain at least three Mentors and a Focus. A Mentor as used herein may be an individual or computer database in an advising, counseling, teaching, leading, providing, or managing position over a Focus. A Focus as used herein may be an individual or computer with an inconsistent internal existence in at least one subject area. Therefore, a group may consist of at least three Mentors and a Focus, where within the group there may exist at least one inconsistent internal existence.

Once a group is provided, the method comprises the step of (b) evaluating the Focus by the at least three Mentors 120. Evaluating the Focus may comprise processing Focus information. Focus information may include the writings of the Focus; oral answers of a Focus to a questionnaire, interview, or survey; prepared speeches or statements by a Focus; medical records of the Focus; observations about the Focus after interfacing in person or on recording; and recordings or oral statements of others based on their knowledge of, transactions with, interactions with, or data collected about the Focus. Further, the Focus information may be data in one or many different areas that may be collected by, with, or through various instruments. As specific examples, the Mentors may use as Focus Information business records, interviews, depositions, surveys, questionnaires, speeches, work-products, reports, financial records, e-mails sent and received, phone logs, phone conversations, intra-office memorandums, medical tests, biosensor readings, psychological analyses, time sheets, body movements & locomotion, facial expressions, tonality in speaking, speech patterns, speech articulation, linguistics analysis, and non-verbal communication observations both of the Focus and derived with respect to the Focus in evaluating the Focus. Further, the Focus information may be related to one subject area or it may be in a wide variety of various subject areas. That is, the Mentors may need to process Focus Information in one or several areas to adequately evaluate the Focus.

After the evaluating the Focus by the at least three Mentors, the method comprises the step of (c) identifying an inconsistent internal existence of the Focus by the at least three Mentors 130. An inconsistent internal existence as used herein may be an irrational patterned behavior or belief, where a Focus' action, thought, or idea in a particular thing or aspect may be concrete and tangible. Within the method, identifying an inconsistent internal existence of a Focus by the at least three Mentors may comprise detecting a Focus' inconsistent internal existence from the Focus information. That is, the at least three Mentors may, for example, analyze, compute, deduce, extrapolate, or approximate from the Focus information examples previously discussed so that the Mentors may thereby detect an inconsistent internal existence in one of more subject areas.

General examples of subject areas in which an inconsistent internal existence may occur include, but are not limited to the following concrete and tangibly measurable areas: management, teamwork, communication, parenting, compulsions/addictions, habits, sleep/fatigue, mental disorders, and social strategy/structure. Further, within each of these exemplary subject areas, there may be many various examples of inconsistent internal existences that the at least three Mentors of a group may identify in a Focus.

The at least three Mentors of a group in a management subject area may, for example, identify the inconsistent internal existence as one or more things, including: poor skills relating to communication, delegation of projects, time management, inept multi-tasking, ineffective delegation skills, or unsound project management techniques, articulation of instructions or expectations, budgeting, planning, efficiency, computers, or business strategy.

In a teamwork subject area, examples of inconsistent internal existences may include: poor interpersonal skills, greed, poor communication, poor attitude, failure to practice, poor priority setting, failure to learn from the lessons, and failure to delegate based on team member attributes.

In a communication subject area, examples of inconsistent internal existences may include poor skills relating to writing (e-mails, reports), hearing, listening, verbal communication (tone, articulation, content, context), and non-verbal communication (facial expression, body language, language gesturing, eye contact, active listening).

In a parenting subject area, examples of inconsistent internal existences may include poor communication, physical, mental, or emotional abuse, mistreatment, disregard for child welfare, absence of mental or emotional support, poor nutrition, unnecessary creation of stress, or poor disciplinary theories.

In an addictions/compulsions subject area, examples of inconsistent internal existences may include smoking, alcohol use/abuse, alcohol addiction, drug use/abuse, drug addiction, sexual abuse, sexual deviance, sex addiction, gambling addiction, violence addiction, compulsive eating habits (includes overeating, under-eating, starvation, and binging/purging), self-loathing or depression to a suicidal tendency, and compulsive shopping.

In a habits subject area, examples of inconsistent internal existences may include poor driving habits, improper caffeine intake, unsafe UV exposure habits, poor security habits, poor or inadequate cleaning habits or skills, and unsafe food handling skills.

In a sleep/fatigue subject area, examples of inconsistent internal existences may include, poor time management, problems addressing anxiety, overwork, sleepwalking, insomnia, excessive stress, improper diet, caffeination, or eating patterns, or sleep deprivation.

In a mental disorder subject area, examples of inconsistent internal existences may include stressors in anger management issues, delusional disorders, anxiety, phobias, depression, and obsessive compulsive disorder.

In a social strategy/structure subject area, examples of inconsistent internal existences may include discrimination, stereotyping, prejudice, gender roles, and assumption about certain individuals or groups based on their race, culture, nationality, religion, sexual orientation, gender, mental capability, impairment, disability, medical condition or diagnosis, age, attractiveness, appearance, class, marital status, socioeconomic status, or wealth.

After the at least three Mentors identify an inconsistent internal existence of the Focus, the method may comprise the step of (d) comparing the inconsistent internal existence to a matrix of consistent internal existence by the at least three Mentors 140. A matrix may be a set, body, or collection of ideas, patterns, behaviors, views, topics, data, or positions of an individual or computer database, based upon on an individual's experience or a computer databases' programming. A consistent internal existence, as used herein, may be a behavior pattern or belief that is considered rational for an individual or computer database to exhibit and articulate based upon a comparison between their own understanding, experience, and reality. A matrix of consistent internal existence may comprise the set, body, or collection of at least one Mentor's factual knowledge, past experiences, and acquired information on at least one subject. For example, a matrix of consistent internal existence may be the set, body, or collection of at least one Mentor's factual knowledge, past experiences, and acquired information on at least one subject, where the Mentor is an expert in that subject area. As another example, the matrix of consistent internal existence may be the set, body, or collection of at least one Mentor's factual knowledge, past experiences, and acquired information on at least one subject, where the Mentor has overcome the same or similar inconsistent internal existence previous to his mentorship role. As yet another example, the matrix of consistent internal existence may be the set, body, or collection of at least one Mentor's factual knowledge, past experiences, and acquired information on at least one subject of a Mentor who had observed someone else as they experienced an inconsistent internal existence in the subject area. Still, the Mentor may be a person that may have no previous experience in the subject area, but may instead use his common sense and common knowledge in the subject area.

Further, comparing the Focus' inconsistent internal existence to a matrix of consistent internal existence may comprise an analysis by the at least three Mentors. That is, the Mentors' analysis may be conducted by selecting one of the following types of analysis, including: group analysis by the at least three Mentors, individual analysis by each individual Mentor of the group, or combinations thereof.

In a group analysis, for example, the at least three Mentors may collectively compare a Focus' inconsistent internal existence to a collective matrix. The collective matrix of consistent existence may be, for example, a summation of each of the at least three Mentors' matrix of consistent existence. For example, in a group analysis approach, the at least three Mentors may discuss and debate each matrix of consistent existence in such a manner that a comparison of the collective matrix versus the identified inconsistent internal existence transpires. In such an approach, there may be group issue spotting, discussion, arguments, debates, reasons and rationales that are articulated.

In an individual analysis, for example, each individual Mentor of the at least three Mentors may individually issue spot, progress through the comparison, reason, and synthesize rationales for their conclusions in their comparison of the identified inconsistent internal existence to the matrix of consistent existence. In such an individual analysis manner, none of the ideas or issues that may be spotted by any one of the at least three Mentors will be selectively abandoned by based on the group valuation of the idea or issue. That is, the process of comparison may be individually completed by each Mentor, for example, in order to pursue the unique perspectives of individuals.

A combination thereof may refer to an individual analysis followed by a group analysis, a group analysis followed by an individual analysis, a series of iterations between group and individual analysis (within a single iteration of the method for resolving an issue), or a hybrid approach. In the hybrid approach, for example, at least two of the at least three Mentors may be engaged in a group of analysis, while at least one of the at least three Mentors may be engaged in an individual analysis. Additionally, it should be noted that in group with more than at least three Mentors, a hybrid group analysis may be comprised of two or more hybrid groups which each complete a group analysis hybrid.

After the comparison is completed by the at least three Mentors, the method comprises the step of (e) providing feedback to the Focus from the at least three Mentors 150. Providing feedback to the Focus may comprise publishing at least one instructed action to the Focus based on the comparison completed by the at least three Mentors of the group. Publishing may refer to any oral, audio, visual, or written communication that is presented to a Focus by or on behalf of the at least three Mentors. An instructed action may include suggestions, advice, guidelines, actions, instructions, goals, commands, mandates, scheduling, or training for the Focus to enact, participate in, undergo, or otherwise complete. Further, the at least three Mentors may also stipulate that the at least one action should be completed in a certain predetermined or preselected post feedback period of time.

After the at least one instructed action is published to a Focus by or on behalf of the at least three Mentors, the method comprises the step of (f) incorporating the feedback by the Focus to create a modified internal existence of the Focus 160. Incorporating the feedback by the Focus to create a modified internal existence 160 may be, for example, completing the at least one instructed action within at least one preselected post feedback time period. A preselected post feedback period of time may be, for example, a minute, an hour, a day, a week, a month, a year, five years, a decade, or a lifetime. Further, a preselected post feedback period of time may include, for example, that at least one instructed action be completed every prescribed cycle, for each prescribed cycle in a preselected post feedback period. As an illustrative example, a Focus may incorporate the feedback from the at least three Mentors by completing the at least one instructed action a week, each week, for a period of three months. Once the Focus incorporates the feedback, the Focus may create a modified internal existence.

A modified internal existence may comprise a resulting behavior pattern or idea of the Focus in at least one subject area after incorporating the feedback of the at least three Mentors of the group. A modified internal existence may be a change from an inconsistent internal existence to a consistent internal existence, consistent with that of the at least three Mentor's matrix of consistent existence. At this point, the method for resolving issues has been completed.

As previously discussed, the method for resolving issues may be applied to one or more areas, including: management, teamwork, communication, parenting, compulsions/addictions, habits, sleep/fatigue, mental disorders, and social strategy/structure. Next, the method for resolving an issue will be discussed with respect to an example regarding managerial training and skills.

In an atmosphere in which one individual may be called upon to manage one or more other individual(s), organization(s), department(s), or compan(y/ies), effective and efficient managerial training and skills are highly valued and sought after. Therefore, the method for resolving issues may be implemented within a managerial skills area. That is, the method for resolving issues may be incorporated into an organization, company, business, or corporate review of employee capabilities, orientation process for employees, or other type of evaluation based program.

A group may be provided, wherein the group includes at least three Mentors and a Focus. In this group, the group members may be composed of managers within a company. The managers may be of equal or differing rank. For example, the at least three Mentors may be upper level managers, while the Focus may be a lower level manager. Also, all of the group members may be employed at the same company.

After the group is provided, the at least three Mentors may evaluate the Focus. In order to determine if a Focus is an effective and efficient manager, the at least three Mentors may evaluate the Focus by processing Focus information. The Focus information may be related to the management skills area, and more particularly, may include the Focus' own perception of their effectiveness and efficiency, as taken through interviews, surveys, or questionnaires. Further, while participating in interviews, the Focus may convey additional Focus information relating to communication capabilities, attitude, competence, or confidence to the interview conductor to record in some fashion, including but not limited to: tonality, facial expression, body language, speech patterns, articulation, verbosity, and other non-verbal communication. Also, the Focus information may include time sheets, e-mail messages, e-mail usage data, phone logs, appointment books, and meeting schedules, which may be used as an illustrative example of how the Focus may undergo a typical day at work. Additionally, the Focus information may include minutes of meetings, agendas of meetings, docketing reports, Focus work products and intra-office memoranda, which may be used as an illustrative example of how the Focus may delegate projects, oversee and manage project completion, communicate to others, or multi-task. Still, even more Focus information, including relevant budget, cost projections, the Focus' management financial records, and expense reports may be used to understand if the Focus is able to properly manage and project the costs and expenses of his position and subordinates. The at least three Mentors may process such information in order to evaluate the Focus in one or more skills areas that may be generally thought to be included in the set of management skills.

After the at least three Mentors evaluate the Focus based on the Focus information, the at least three Mentors may identify an inconsistent internal existence of the Focus' management skills. For example, after evaluating information relating to the Focus' perception of their management capabilities, the Focus' communication capabilities, the Focus' attitude, competence, and confidence; the time spent per activity and activities completed in a typical day of work; the Focus' delegation abilities and overseeing skills of those projects, including multi-tasking; and financial awareness and responsibility, the at least three Mentors may be able to identify at least one internal inconsistent existence of the Focus.

For example, a Focus may not communicate well in the written word, and so intra-office memorandums, reports, e-mails and the like may be unclear and confusing to those that the Focus communicates with, delegates work to, or otherwise gives instructions to on a daily basis. Here, the at least three Mentors may identify an inconsistent internal existence in the Focus as poor written communication skills.

As another example, a Focus may not manage their time well, as they may: micro-manage projects that they have already delegated to others; spend too much time out of the office; spend too little time returning phone calls and e-mails; answer each e-mail they receive as it comes in, thereby distracting themselves from the task at hand; or, are single-sighted in task completion in lieu of multi-tasking many assignments at once. Here, the at least three Mentors may identify an inconsistent internal existence as poor time management skills.

After the at least three Mentors have identified an inconsistent internal existence of the Focus, the at least three Mentors may compare the inconsistent internal existence to a matrix of consistent internal existence by the at least three Mentors. A matrix of consistent internal existence of a Mentor may comprise a set, body, or collection of ideas, patterns, behaviors, views, topics, data, or positions of the Mentor. In this example, a matrix of consistent internal existence may also comprise the organization's guidelines, training manuals, efficiency expert projections, organization expectations, and any other documents published by or on behalf of the organization implementing the method for resolving an issue. A consistent internal existence may be a behavior pattern or belief that is considered rational for an individual or computer database to exhibit and articulate based upon a comparison between their own understanding, experience, and reality. In the comparison, each of the at least three Mentors analyzes the Focus information in context against each Mentor's matrix of consistent internal existence within a managerial skills area. The managerial skills area for each Mentor may contain factual knowledge about being a manager and the managerial skills requisite to performing an adequate managing job; past experiences about both being managed and managing others including methods, examples, and effective practices; and acquired information which may be the product of a long history with the organization, best methods and practices to conform to the organizations expectations managers, and any published information that details the practices and methodology behind managing. As previously discussed, the at least three Mentors of a group may analyze the Focus information against their matrices of consistent internal existence by group analysis, individual analysis, or combinations thereof.

After the comparison, which may be done by at least three Mentors, the at least three Mentors provide feedback to the Focus. Providing feedback to the Focus may be done by publishing at least one instructed action to the Focus as a result of the comparison. As previously stated, publishing may refer to any oral, audio, visual, or written communication that is presented to a Focus by or on behalf of the at least three Mentors. In a managerial skills area, the at least one instructed action published to a Focus may be an evaluation, in which the Focus is presented with a detailed analysis of how they spend their time each day as a manager, with at least one instructed action included in the evaluation. The at least one instructed action items may be, for example, instructions to the Focus for frequency of checking organization e-mail or guidelines for responding thereto.

As another example, at least one instructed action may be for the Focus to take a course in effectively communicating and articulating instructions in the written word, including drafting reports, intra-office memoranda, and e-mails.

Alternatively, still another example may be for the Focus to take a course in public speaking, in order to provide the Focus with speaking confidence, clarity, articulateness, and positive body language when the Focus is speaking with subordinates, superiors, and colleagues of the organization. Further, in providing feedback by publishing at least one instructed action to the Focus, the at least three Mentors may also publish a post feedback time period in which the instructed action may be done to avoid alternative action outside the method for resolving issues, as previously discussed.

After the Focus has received the feedback from the at least three Mentors, the Focus may incorporate the feedback such that the Focus may create a modified internal existence. A Focus may incorporate the feedback by completing the at least one instructed action within at least one preselected post feedback time period. For example, an evaluation published to a Focus containing an instructed action may state that a Focus is to check their e-mail only once every two hours, and spend only fifteen minutes responding to e-mails after each check. This instruction may be given with a preselected time period of one month, so that the Focus must practice the instructed action for e-mail procedures each work day for one month. By following the instructed action for the preselected post feedback time period, the Focus may become aware to the frequency in which be should check his e-mail, and adapt accordingly so that the Focus' time is managed much more appropriately during a given work day. Also, the Focus may be given at least one instructed action that should be completed for every prescribed cycle, for as many cycles that may be in a preselected post feedback time. For example, if a Focus is identified to have poor written communication skills, the Focus may be instructed, for example, to take one writing course per week in various drafting areas including e-mail, report, meeting agenda, or memoranda, for a period of two months. Also, the at least three Mentors may also include as an additional instructed action that the courses may cease after two months, pending another evaluation of the Focus' written products that are given out at the organization. At the completion of the at least one instructed action, the Focus has created a modified internal existence. That is, the Focus has created a resulting behavior pattern or idea in the managerial skills area. For example, after following an e-mail procedure and guidelines for responding to e-mails, the Focus may no longer check and respond to each e-mail as they are received, thereby distracting their attention from the task at hand. After following the e-mail guidelines, the Focus will manage his time more efficiently by checking and responding to his e-mail at lower, focused frequencies.

The resulting modified internal existence may be measured and verified in the same ways that the Focus may have been evaluated, through the gathering and processing of Focus information. Similarly, Focus's modified internal existence that is created through taking writing courses or public speaking courses may be measurable and verifiable. That is, the written and oral communications may be gathered and evaluated, or, in the alternative, those persons that may be recipients of such written or oral communications may report or otherwise evaluate the Focus on those communications with respect to articulateness, clarity, verbosity, and effectiveness.

As an additional example, the method for resolving an issue may be applied in a sleep/fatigue subject area. The method for resolving an issue may be implemented in any group or organization that wishes to address the rest/sleep issues of its participants or associates. Alternatively, an individual may come forward to a membership or organization in order to reconcile what the individual may perceive as their own sleep/fatigue problems. All organizations and individuals may seek to promote sound rest, as proper rest is essential to maintaining alertness, sharpness, thinking capacity, and mental stride throughout the day, each and every day. Such swift thinking with a quickly paced intellect may be highly sought after in many various work fields. Although individuals may be able to properly function on various amounts of sleep, each person usually requires a certain threshold of uninterrupted rest. Therefore, the method for resolving an issue may be applied to the sleep/fatigue subject area to identify and resolve any inconsistent internal existence that may cause an individual to suffer in a sleep/fatigue subject area.

A group may be provided, wherein the group includes at least three Mentors and a Focus. In this example, the Focus may be an individual with an issue related to sleep/fatigue. The at least three Mentors of the group may be composed of, for example, sleep experts, physicians, members of the same workforce (same job position or career), or laypersons with respect to sleep science. Further, the at least three Mentors may either be known (family, friend, acquaintance, long-time physician, or preceding reputation) or unknown by the Focus.

After the group is provided, the at least three Mentors may evaluate the Focus. In order to determine if a Focus is an effective or efficient sleeper, the at least three Mentors may evaluate the Focus by processing Focus information. The Focus information may be related to the sleep or rest characteristics area, and more particularly, may include the Focus' own perception of their sleep habits, nighttime restlessness, quality of rest, waking frequencies, and alertness during the day, as taken through interviews, surveys, or questionnaires. Further, while participating in interviews, the Focus may convey additional Focus information relating to alertness in comprehension and communication capabilities, attitude towards sleep/rest to the interview conductor to record in some fashion, including but not limited to: tonality, facial expression, body language (i.e. yawning), speech patterns, articulation, verbosity, and other non-verbal communication. Also, the Focus information may include sleep log data (time of uninterrupted sleep, waking frequency, phase of sleep progression (light sleep versus rapid eye movement (or REM)), diet, caffeine intake, and workload (including phone logs, appointment books, and meeting schedules). Other Focus Information may include the physical domain of sleep, and may, for example, include: type of sleep clothing, type of bedding, or type of mattress/bed. The at least three Mentors may process such information in order to evaluate the Focus in one or more characteristic areas that may be generally thought to be included in the sleep/fatigue field.

After the at least three Mentors evaluate the Focus based on the Focus information, the at least three Mentors may identify an inconsistent internal existence of the Focus' sleep behaviors or fatigue characteristics. In a sleep/fatigue subject area, examples of inconsistent internal existences may include, poor time management, uncomfortable sleeping environment, problems addressing anxiety, overwork, sleepwalking, insomnia, excessive stress, poor/improper diet, over-caffeination, or sleep deprivation.

Once the Focus Information relating to the Focus' perception of their sleep habits and sleep log data has been evaluated, the Focus' time actually sleeping may be determined. As an illustrative example, a Focus may only sleep for an average of two hours a night. This average amount of sleep, which is well under the typical average, may be indicative or otherwise caused by one or more inconsistent internal existences.

For example, a Focus may be interrupted during sleep. Such interruptions may be the cause of loud environmental noises, infants/small children, or a high frequency of phone calls late at night. These occurrences may cause the Focus to awaken from sleep or otherwise be interrupted at a high frequency. Therefore, the high frequency of nighttime interruptions may be an inconsistent internal existence that may contribute to a Focus getting an average of two hours of sleep per night.

As another example, a Focus may not follow a balanced diet, and so, the times of consumption, the amount consumed, or the type of food or beverage consumed may affect the Focus' sleep patterns and behaviors. That is, if a Focus ate a large meal immediately before bed, the Focus may not rest as comfortably. Or, if a Focus drank excessive amounts of liquid prior to sleeping, the Focus may be periodically awakened from slumber in order to urinate. Also, if the Focus imbibed a large quantity of caffeine prior to attempting to sleep, the caffeine may cause the Focus to be nervous or anxious, and therefore be unable to properly rest or sleep. Here, the at least three Mentors may identify the inconsistent internal existence as poor diet or caffeination which in turn causes the Focus to get on average only two hours of sleep per night.

After the at least three Mentors have identified an inconsistent internal existence of the Focus, the at least three Mentors may compare the inconsistent internal existence to a matrix of consistent internal existence by the at least three Mentors. A matrix of consistent internal existence of a Mentor may comprise a set, body, or collection of ideas, patterns, behaviors, views, topics, data, or positions of the Mentor. In this example, a matrix of consistent internal existence may also comprise common knowledge on sleep, physician or expert publications relating to methods of rest or facilitating sleep, printed publications on sleep, dealing with anxiety or stress, nutritional information and publications, career norms and guidelines of others in the Focus' career field, and opinions of persons dealing with sleep, anxiety, rest, nutrition, et cetera. A consistent internal existence may be a behavior pattern or belief that is considered rational for an individual or computer database to exhibit and articulate based upon a comparison between their own understanding, experience, and reality. In the comparison, each of the at least three Mentors analyzes the Focus information in context against each Mentor's matrix of consistent internal existence within a sleep habits and behaviors subject area. The sleep habits and behaviors subject area of each Mentor may contain factual knowledge about sleeping, nutrition, or stress; past experiences about sleeping, nutrition, or stress, including methods, examples, and effective practices; and acquired information about sleeping, nutrition, or stress, which may be the product of a long history with the subject area, best methods and practices to conform towards target sleep times, and any published information that details the practices and methodology promoting proper sleep, nutrition, or stress management. As previously discussed, the at least three Mentors of a group may analyze the Focus information against their matrices of consistent internal existence by group analysis, individual analysis, or combinations thereof.

After the comparison, which may be done by at least three Mentors, the at least three Mentors provide feedback to the Focus. Providing feedback to the Focus may be done by publishing at least one instructed action to the Focus as a result of the comparison. As previously stated, publishing may refer to any oral, audio, visual, or written communication that is presented to a Focus by or on behalf of the at least three Mentors. In a sleep behaviors and practices subject area, the at least one instructed action published to a Focus may be a sleep log evaluation, in which the Focus is presented with a detailed analysis of how they sleep, with at least one instructed action included in the evaluation. Further, in providing feedback by publishing at least one instructed action to the Focus, the at least three Mentors may also publish a post feedback time period in which the instructed action may be done to avoid alternative action outside the method for resolving issues, as previously discussed. The at least one instructed action items may be, for example, instructions to the Focus to sleep better, incorporate better nutrition into their lifestyle, or deal with stress more effectively.

One instructed action may be for the Focus to spend eight hours each night in a dark room in a bed, in which the Focus should have their eyes closed, resting. Another instructed action may be to quantitatively limit the Focus' intake of caffeine per day or within a certain time frame.

After the Focus has received the feedback from the at least three Mentors, the Focus may incorporate the feedback such that the Focus may create a modified internal existence. A Focus may incorporate the feedback by completing the at least one instructed action within at least one preselected post feedback time period. For example, a Focus instructed to spend eight hours each night in a dark room in a bed, with eyes closed, resting, may be told to do so every day for a month. By following the instructed action for the preselected post feedback time period, the Focus may become aware to the sleep routine that should be followed, and adapt accordingly so that the Focus is resting for an appropriate amount of time per day. As the other example provided, if the Focus is instructed to limit the intake of caffeine over a certain timeframe for a prescribed cycle of a month, the Focus may grow accustomed to functioning without caffeine at certain times of a day, or entirely. Without caffeine, the Focus may in turn find that the absence of caffeine induced nervousness or anxiety makes it easier to get to sleep and stay asleep each night. Further, the Focus may be given at least one instructed action that should be completed for every prescribed cycle, for as many cycles that may be in a preselected post feedback time.

At the completion of the at least one instructed action, the Focus may have created a modified internal existence. That is, the Focus may have created a resulting behavior or pattern in the sleep/fatigue subject area. For example, after following a night time routine of going to a dark room, lying in bed, closing one's eyes, and resting, a Focus may increase their nightly sleep from an average of two hours to an average of five, seven, or eight hours. As another example, after following a dietary guideline or caffeine limitation, the Focus may be able to get to sleep sooner, stay asleep longer, and overall, get more sleep per day. The resulting modified internal existence may be measured and verified in the same ways that the Focus may have been evaluated, through the gathering and processing of Focus Information.

As previously stated, a modified internal existence may, but need not, be a change in the Focus from an inconsistent internal existence to a modified internal existence which is consistent with that of the at least three Mentor's matrix of consistent existence. That is, upon completing the method for resolving an issue, the Focus may, as a result of the method for resolving an issue, have a consistent internal existence in the subject area in which the method was performed. However, a Focus may also, as a result of performing the method for resolving in issue, have a modified internal existence which may be different from the initial inconsistent internal existence and closer to a consistent internal existence, but may not yet be considered a consistent internal existence. Therefore, in such a case in which the modified internal existence of the Focus is not consistent with the at least three Mentors' matrix of consistent existence, the method of resolving an issue may be repeated or reiterated until a desired result may be reached.

FIG. 2 illustrates a flow chart of a method for resolving an issue with reiteration. The method, as articulated inter alia, may further comprise the step of reiterating steps (b) through (f) until the step of (c) identifying the inconsistent internal existence of a Focus step yields no identifiable inconsistent internal existence, yielding the method for resolving issues 170. That is, the at least three Mentors, after the step of (b) evaluating the Focus by the at least three Mentors 120, may be unable to detect a Focus' inconsistent internal existence from the Focus information, and may thereby fail in the identifying step. A failure to identify an inconsistent internal existence in the identifying step may thereby yield the method. The method may be reiterated, for example: once, twice, or many times until an inconsistent internal existence is no longer identified by the at least three Mentors.

Alternatively, it should be noted that there may be a fail safe step incorporated into the method in order to prevent ineffective, inefficient, or other detrimental results to the method. For example, if the Focus does not, cannot, or otherwise refuses to properly incorporate the feedback from the at least three Mentors, then the Focus may not be said to realize a modified internal existence as a result of the process. Therefore, in the previous example, it may not matter the number of times the method is reiterated. If method steps are incomplete due to a non-compliant Focus, repeating the method may not show progress or beneficial results and may be ceased. Additionally, if the reiteration of the method becomes a burden to the time, resources, or efficiency of the at least three Mentors, the Focus, the group, or an organization sponsoring the use of the method, the method may be ceased. In such rare examples, the Focus may be recommended to one or more areas outside of the method, including but not limited to: disciplinary action, outside counseling (including diversity training, psychology sessions, psychiatry sessions, or other therapy sessions), reporting to law enforcement, legal, or administrative authorities, substance abuse rehabilitation, intervention, hospitalization, or mental health facilities.

Referring again to the reiteration step of the method for resolving issues, the step of reiterating steps (b) through (f) until the step of (c) identifying the inconsistent internal existence of a Focus step yields no identifiable inconsistent internal existence, yielding the method 170, may be completed in an alternate fashion. That is, there may be a step in the method that may further comprise providing a process of transforming a previous group into a subsequent group 180, so that the method for resolving an issue may be reiterated through a plurality of groups.

FIG. 3 illustrates a flow chart of a method for resolving an issue with reiteration using a plurality of groups, in which a previous group may be transformed into a subsequent group 180 prior to reiteration 170. A plurality of groups, as used herein, is a gathering of two or more groups to facilitate, for example, the reiteration of the method from steps (b) through (f). Examples of a plurality of groups include, but are not limited to: a conference with fifty attendees organized into two groups of twenty five members; a classroom of twenty individuals organized into five groups of four members; a discussion group of thirty people organized into six groups of five members; or one or more computer databases which simulate such groupings.

In the plurality of groups, each group may include at least three Mentors and a Focus, further wherein after steps (b) through (f) may be completed in a previous group, steps (b) through (f) may be subsequently reiterated in a subsequent group of the plurality of groups. That is, after a previous group may complete the method for resolving an issue in FIG. 3, as articulated in steps 120 through 160, the previous group may be transformed into a subsequent group 180 and the reiteration of the method 170 may then take place with the subsequent group. Further, through one or more processes, the previous group may be transformed into the subsequent group.

Prior to reiterating the method as articulated in steps 120 through 160 a previous group is transformed into a subsequent group by performing at least one process, at which point the subsequent group may complete steps 120 through 160 of the method for resolving an issue. Referring to FIG. 4, after providing a previous group 111, one or more operations may be performed on the previous group, such that, the end of the process provides a subsequent group 112. Transforming a previous group into a subsequent group 180 may be done through a series of operations or combinations of those operations, as illustrated in FIG. 4, including, for example: adding at least one subsequent Mentor 121; deleting at least one previous Mentor 122; replacing at least one previous Mentor with at least one subsequent Mentor while maintaining the previous Focus 123; replacing the previous Focus with a subsequent Focus while maintaining the previous at least three Mentors 124; changing the previous Focus into a subsequent Mentor and adding a subsequent Focus 125; changing the previous Mentor into a subsequent Focus and deleting the previous Focus 126; doing nothing 127; and a combination thereof 128. Further, once the at least one process may be complete; the subsequent group may have at least three Mentors and one Focus. Next, each of the transforming processes previously recited will be discussed.

Adding at least one subsequent Mentor 121 may include, for example, adding one subsequent Mentor, two subsequent Mentors, or many subsequent Mentors in order to transform a previous group into a subsequent group.

Deleting at least one previous Mentor 122 may include, for example, deleting one previous Mentor, two previous Mentors, many previous Mentors, or all previous Mentors in order to transform a previous group into a subsequent group.

Replacing at least one previous Mentor with at least one subsequent Mentor while maintaining the previous Focus 123 may include, for example, replacing one, two, many, or all of the previous Mentors with subsequent Mentors in order to transform a previous group into a subsequent group.

Replacing the previous Focus with a subsequent Focus while maintaining the previous at least three Mentors 124 comprises replacing the Focus for the subsequent group while maintaining the at least three Mentors in order to transform a previous group into a subsequent group.

Changing the previous Focus into a subsequent Mentor and adding a subsequent Focus that may not have been a previous Mentor 125 may be done in order to transform a previous group into a subsequent group. This may be done, for example, to prevent the previous Focus from mentoring the previous Mentor in a subsequent group. That is, the previous Focus may not be the subsequent Mentor for a subsequent Focus that was the previous Mentor to that subsequent Mentor. Such a guideline may be, for example, because the previous Focus, once put into the mentorship role as a subsequent Mentor, may not be able to effectively and zealously evaluate, identify, compare, and provide feedback and instructed actions to a previous Mentor that previously critiqued her. It should be noted that a previous Focus and previous Mentor may be peers or colleagues in subsequent Mentor roles when, for example, a new Focus (subsequent Focus) may be added to transform a previous group into a subsequent group.

Changing the previous Mentor into a subsequent Focus and adding subsequent Mentor that may not have been a previous Focus 126 may transform a previous group into a subsequent group. This may be done, for example, to prevent a complete power shift between the Focus and Mentor as they change roles. Similar to the case previously discussed, here too, the previous Focus, once put into the mentorship role as a subsequent Mentor, may not be able to effectively and zealously evaluate, identify, compare, and provide feedback and instructed actions to a previous Mentor that previously critiqued her. That is to say, the previous Mentor may not be the subsequent Focus for the previous Focus that is the subsequent Mentor, respectively.

A previous group may be transformed into a subsequent group by doing nothing 127. Doing nothing may be reiterating the method 170, with steps 120 through 160 with the same group members as the initial groups, in the same roles (same Focus and at least three Mentors), but that the group may now termed a subsequent group. Referring to FIG. 4, doing nothing is essentially not performing operations 121, 122, 123, 124, 125, and 126. For example, doing nothing as a transformation may be especially helpful to a Focus that may wish to learn more from the at least three Mentors of a grouping, while keeping the same group dynamic for two or more iterations of the method prior to arranging or transforming a previous group into a subsequent group by changing the Mentorship or Focuship.

Further, combinations of adding, deleting, changing, replacing, and doing nothing, as previously articulated, may be performed in order to transform a previous group into a subsequent group 180. Referring to FIG. 4, this may be done by either performing or not performing (termed YES or NO in FIG. 4) each of the operations as listed, 121, 122, 123, 124, 125, and 126.

At the end of transforming a previous group into a subsequent group, the subsequent group may conform to the aforementioned guidelines. That is, in any group there may be a Focus and at least three Mentors, and in a subsequent group, there may be no complete role reversal of a previous Focus and a previous Mentor into a subsequent Mentor and subsequent Focus, respectively.

FIG. 5 illustrates a flow chart depicting a method for blindly resolving an issue 200. This method for blindly resolving an issue 200 comprises: (a) providing a group, wherein the group includes at least three Mentors and a Focus 210; b) blinding the group, wherein the at least three Mentors are blind as to the Focus 220; (c) evaluating the Focus by the at least three Mentors 230; (d) identifying an inconsistent internal existence of the Focus by the at least three Mentors 240; (e) comparing the inconsistent internal existence to a matrix of consistent internal existence by the at least three Mentors 250; (f) providing feedback to the Focus from the Mentors 260; and (g) incorporating the feedback by the Focus to create a modified internal existence of the Focus 270. Each of the steps of this embodiment is discussed in detail in the paragraphs below.

The method for blindly resolving an issue 200 comprises (a) providing a group, wherein the group includes at least three Mentors and a Focus 210. A group as used herein may be a number of individuals or computer databases having responses that would have or simulate a particular human personality, gender, and age.

An individual as used herein is a human. An individual may have derived information, facts, theories, hypotheses, memories, and experiences from their day to day encounters, interactions, and occurrences. Such information, facts, theories, hypotheses, memories, and experiences may interact with each individual's strengths, weaknesses, temperament, physical, mental, and emotional characteristics to derive a particular human personality trait. Similarly, one or more computers may be used to portray human personality traits. For example, computers may be equipped with artificial intelligence to synthesize certain emotional-type tendencies and likelihoods. As another example, a computer may be programmed such that, through the completion of various processes, operations, or algorithms, an individual's personality trait, age, and gender may be computer-simulated and articulated as any individual may indicate or articulate their personality traits, age, or gender to others. Referring to a group herein may refer to the individuals, computer databases, or a combination of both that may be gathered, assembled, or recognized as together to comprise the present method.

Each group may contain at least three Mentors and a Focus. A Mentor as used herein may be an individual or computer database in an advising, counseling, teaching, leading, providing, or managing position over a Focus. A Focus as used herein may be an individual or computer with an inconsistent internal existence in at least one subject area. Therefore, a group may consist of at least three Mentors and a Focus, where within the group there may exist at least one inconsistent internal existence.

Once a group is provided, the method for blindly resolving an issue 200 comprises the step of (b) blinding the group, wherein the at least three Mentors may be blind as to the Focus 220. It should be noted that the blinding may also include, for example, blinding the Focus to the at least three Mentors, or blinding the Mentors to the other Mentors in the group. Further, blinding a group may comprise implementing a communication formatting system. The communication formatting system may, for example, be a blind exchange apparatus, one or more operation standards, or a combination thereof. It should be noted that in certain cases, it may be advantageous to blind each Mentor from other Mentors, to blind the Focus from the at least three Mentors, or to blind previous group members from subsequent group members. In these examples listed, the same communication formatting system may be employed to create anonymity between any or all participants in the method for blindly resolving an issue.

A blind exchange apparatus may refer to the physical parameters of information exchange that contribute to anonymity of the Focus or group member. A set of operation standards may refer to the procedural parameters that contribute to anonymity of the Focus or group member. Both the blind exchange apparatus and the set of operation standards, in cooperation, further secure the anonymity of the Focus (or other group members) and confidentiality of the relevant information disclosed by such.

For example, a blind exchange apparatus may be a Postal Servicer drop box and related postal system. With such a system, the Focus may discreetly and inconspicuously drop off a request for review or other related Focus Information, directed to the attention of the at least three Mentors. Alternatively, the Focus may direct the letter to the attention of an organization at large, which will in turn blindly give the information to the at least three Mentors. Once the Focus drops the mail message in the box, the correlating pick up service, for example, USPS, Foreign Postal Service, DHL, UPS, FedEx, acts as an intermediate, and both picks up the message and drops the message off to the addressed party or organization.

Another example of a blind exchange apparatus may be a private drop box, where access to the contents of the drop box is only accessible to one or more authorized parties. In such an example, the box may be located in one or more remote locations, or on one or more locations directly on an organization's property or land. In a remote location, there will likely be less potential observers to the Focus' presence and activities related to the drop box. In a proximal location to the organization, there will likely be a high frequency of traffic in the immediate proximity to the drop box, such that a direct correlation of identify of the Focus to the Focus message dropped in the box will be unlikely. Further, the private drop box may be conspicuously labeled as such for pre-sorted entry, or the secure drop box may be a collective area for comments, concerns, surveys, questions, or other information exchange to take place. In the latter example, there may be an increase in user traffic, further lessening the probability that the Focus disclosing information relevant to the method for blindly resolving issues will be identified as such. Further, the box may be locked or otherwise secured via an alarm to prevent unauthorized parties from gaining access to the private drop box. Alternatively, the secure drop box may have a collection site at the face of the private drop box in which those things placed into the collection site are routed to a secret and/or secure storage location until they can be sorted, distributed, and addressed individually.

In addition to a physical drop box, an additional example of a blind exchange apparatus is computer drop box (or generic electronic drop box) may be utilized to collect Focus information or issues that are to be addressed with the Method for blindly resolving issues. However, with the advent of personal computers, tracing a user or origin via IP address has come into the realm of common knowledge. Therefore, should a computer drop box be utilized, it should be through a computer that is not easily affiliated with the identity of the disclosing Focus. That is, the computer drop box may be, as non-limiting examples, an e-mail message, an instant message, a comment or query on a web page, or an open-sourced blog. The computer used to relay the information may be one that a plurality of users have access to, either within the organization or in the public at large. Further, if an e-mail, instant message, or online comment or query is made, it should be done from an anonymous or organization user name to which a plurality of users have access to, and use on a high traffic, regular frequency basis. If a computer or other electronic drop box is used in such a manner, it may be as anonymous as a physical drop box. Further, the Internet, World Wide Web, intranet, and various servers as are known by those skilled in the art are inherently included in the references to e-mail, posting comments or queries, instant messaging, or other electronic communication. Then, the relevant information may be transmitted or otherwise communicated to the at least three Mentors.

As still another example of a blind exchange apparatus drop box, a telephone drop box may be employed. That is, with the use of, for example, a voice scrambling mechanism or computer aid that reads typed text (where the computer is one of those discussed in the previous paragraphs), a phone call may be placed and the relevant information may be relayed to be addressed by the Method for blindly resolving issues. The phones may be located on site for an organization, in public access, or otherwise scrambled to disguise the location from which the call was placed. The recipient of a call may be a human operator, a voice mail system, or a computer system. The relevant information may be transmitted or otherwise communicated to the at least three Mentors.

With any of the previous blind exchange apparatus' employed, a set of corresponding operation standards may also be employed. There are many various procedural parameters that may contribute to maintaining and preserving the anonymity the Focus (or group member) and the confidentiality of the information disclosed.

An example of an operation standard to may be to implement linguistic frames in the message. Linguistic frames may streamline the disclosure and prevent any linguistic clues as to the origin of the Focus or other group member. The framework may ensure against unique sayings, clichés, spelling, slang, or identifying language or terminology from becoming a part of the message. Even though such unique sayings or identifying language may not identify a single user, employing such framework universally in communication will perpetuate a practice and common procedure for interaction that will further dispel any probability of discovery through deduction of the Focus or other group member.

Another example of an operation standard may be to disclosure relevant information only through typed words. Handwriting is a common evidentiary identifying characteristic. Typing and printing the disclosure may further ensure that the Focus or other group member may not be discovered or deduced to be the disclosing party. Additionally, it should be noted that computer printers, facsimile machines, photocopiers, or electronic scanners may sometimes leave identifying characteristics. Therefore, an operation standard within the typing standard to prevent identifying a Focus or other group member may also be that all printed disclosures be printed from an anonymous machine, a machine on the organization's premises, or a machine that is publicly available and has a high frequency and traffic of use.

Still another example of an operation standard may be that no identifying labels are used. That is, a Focus or other group member sending relevant information for the method of blindly resolving issues may not, for example, include his real name, address, or other identifying information on any communications. A code may be used as an identifier of the issue, such that the relevant parties of a group that relay information about the coded issue may use the identifying code to address the issue. By following such a protocol, the groups need not identify themselves, but rather, only the issue in which they are discussing. Similarly, a Focus may be given a code anonymously. This code may then be the identifying information by which the related communications may be addressed. Further, the organization, the at least three Mentors, or the Focus may confirm the receipt of a communication pertaining to the relevant issue by, for example, relaying a code-identifying confirmation through the blind exchange apparatus, or by posting a receipt confirmation in plain sight on the organization's premises.

Still, yet another example of an operation standard may be that an organization completing a method for blindly resolving an issue may institute a policy to mandate that all members drop messages into the drop box, and further, that all members may be required to do so in certain frequencies. Further, if the members do not have inconsistent internal existence-related disclosures, then such members may be instructed to make arbitrary or dummy disclosures in certain frequencies. Employing this operation standard may further eliminate the probability of properly identifying a Focus or other group member based on a physical presence deduction near an implemented blind exchange apparatus.

Therefore, once a group has been blinded with the blinding exchange apparatus and the corresponding operation standards for communication, the identification the Focus may not be discovered by any of the at least three Mentors, subsequent participants in the method, or by an outside party.

Once a group is blinded, the method for blindly resolving an issue 200 comprises the step of (c) evaluating the Focus by the at least three Mentors 230. Evaluating the Focus may comprise processing Focus information. Focus information may include the writings of the Focus; oral answers of a Focus to a questionnaire, interview, or survey; prepared speeches or statements by a Focus; medical records of the Focus; observations about the Focus after interfacing in person or on recording; and recordings or oral statements of others based on their knowledge of, transactions with, interactions with, or data collected about the Focus. The Focus information may be data in one or many different areas that may be either directly disclosed by the Focus, or alternatively, collected via various instruments. As specific examples, the Mentors may use as Focus Information business records, Interviews, depositions, surveys, questionnaires, speeches, work-products, reports, financial records, e-mails sent and received, phone logs, intra-office memorandums, medical tests, biosensor readings, psychological analyses, time sheets, body movements & locomotion, facial expressions, tonality in speaking, speech patterns, speech articulation, linguistics analysis, and non-verbal communication observations both of the Focus and derived with respect to the Focus in evaluating the Focus. Further, the Focus information may be related to one subject area or it may be in a wide variety of various subject areas. That is, the Mentors may need to process Focus Information in one or several areas to adequately evaluate the Focus. It should be noted that Focus information may be adequate to implement the method for blindly resolving an issue, but still may be inadequate to identify the Focus.

After the evaluating the Focus by the at least three Mentors, the method for blindly resolving an issue 200 comprises the step of (d) identifying an inconsistent internal existence of the Focus by the at least three Mentors 240. An inconsistent internal existence as used herein may be an irrational patterned behavior or belief, where a Focus' action, thought, or idea in a particular thing or aspect may be both recognizable and measurable. Within the method, identifying an inconsistent internal existence of a Focus by the at least three Mentors may comprise detecting a Focus' inconsistent internal existence from the Focus information. In addition, identifying an inconsistent internal existence of a Focus may be interpreting a Focus information disclosure deposited into the blind exchange apparatus by the Focus after implementing the operation standards. That is, the at least three Mentors may, for example, analyze, compute, deduce, extrapolate, or approximate from the Focus information examples previously discussed so that the Mentors may thereby detect an inconsistent internal existence in one of more subject areas.

General examples of subject areas in which an inconsistent internal existence may occur include, but are not limited to: management, teamwork, communication, parenting, compulsions/addictions, habits, sleep/fatigue, marketing and advertisement, mental disorders, and social strategy/structure. Further, within each of these exemplary subject areas, there may be many various examples of inconsistent internal existences that the at least three Mentors of a group may identify in a Focus.

The at least three Mentors of a group may, for example, in a management subject area, identify the inconsistent internal existences may include poor skills relating to communication, delegation of projects, time management, inept multi-tasking, ineffective delegation skills, or unsound project management techniques, articulation of instructions or expectations, budgeting, planning, efficiency, computers, or business strategy.

In a teamwork subject area, examples of inconsistent internal existences may include: poor interpersonal skills, greed, poor communication, poor attitude, failure to practice, failure to learn from the lessons, and failure to delegate based on team member attributes.

In a communication subject area, examples of inconsistent internal existences may include poor skills relating to writing (e-mails, reports), hearing, listening, verbal communication (tone, articulation, content, context), and non-verbal communication (facial expression, body language, language gesturing, eye contact, active listening).

In a parenting subject area, examples of inconsistent internal existences may include poor communication, physical, mental, or emotional abuse, mistreatment, disregard for child welfare, absence of mental or emotional support, poor nutrition, unnecessary creation of stress, and poor disciplinary theories.

In an addictions/compulsions subject area, examples of inconsistent internal existences may include smoking, alcohol use/abuse, alcohol addiction, drug use/abuse, drug addiction, sexual abuse, sexual deviance, sex addiction, gambling addiction, violence addiction, compulsive eating habits (includes overeating, starvation, and binging/purging), self-loathing to a suicidal tendency, and compulsive shopping.

In a habits subject area, examples of inconsistent internal existences may include poor driving habits, caffeine intake, UV exposure habits, poor security habits, poor or inadequate cleaning habits or skills, and unsafe food handling skills.

In a sleep/fatigue subject area, examples of inconsistent internal existences may include, poor time management, problems addressing anxiety, overwork, sleepwalking, insomnia, excessive stress, or sleep deprivation.

In a mental disorder subject area, examples of inconsistent internal existences may include stressors in anger management issues, delusional disorders, anxiety, phobias, depression, and obsessive compulsive disorder.

In a social strategy/structure subject area, examples of inconsistent internal existences may include discrimination, stereotyping, prejudice, gender roles, and assumption about certain individuals or groups based on their race, culture, nationality, religion, sexual orientation, gender, mental capability, impairment, disability, medical condition or diagnosis, age, attractiveness, appearance, class, marital status, socioeconomic status, or wealth.

After the at least three Mentors identify an inconsistent internal existence of the Focus, the method for blindly resolving an issue 200 may comprise the step of (e) comparing the inconsistent internal existence to a matrix of consistent internal existence by the at least three Mentors 250. A matrix may be a set, body, or collection of ideas, patterns, behaviors, views, topics, data, or positions of an individual or computer database, based upon on an individual's experience or a computer databases' programming. A consistent internal existence, as used herein, may be a behavior pattern or belief that is considered rational for an individual or computer database to exhibit and articulate based upon a comparison between their own understanding, experience, and reality. A matrix of consistent internal existence may comprise the set, body, or collection of at least one Mentor's factual knowledge, past experiences, and acquired information on at least one subject. For example, a matrix of consistent internal existence may be the set, body, or collection of at least one Mentor's factual knowledge, past experiences, and acquired information on at least one subject, where the Mentor is an expert in that subject area. As another example, the matrix of consistent internal existence may be the set, body, or collection of at least one Mentor's factual knowledge, past experiences, and acquired information on at least one subject, where the Mentor has overcome the same or similar inconsistent internal existence previous to his mentorship role. As yet another example, the matrix of consistent internal existence may be the set, body, or collection of at least one Mentor's factual knowledge, past experiences, and acquired information on at least one subject of a Mentor who had observed someone else as they experienced an inconsistent internal existence in the subject area. Still, the Mentor may be a person that may have no previous experience in the subject area, but may instead use his common sense and common knowledge in the subject area.

Further, comparing the Focus' inconsistent internal existence to a matrix of consistent internal existence may comprise an analysis by the at least three Mentors. That is, the Mentors' analysis may be conducted by selecting one of the following types of analysis, including: group analysis by the at least three Mentors, individual analysis by each individual Mentor of the group, or combinations thereof.

In a group analysis, for example, the at least three Mentors may collectively compare a Focus' inconsistent internal existence to a collective matrix. The collective matrix of consistent existence may be, for example, a summation of each of the at least three Mentors' matrix of consistent existence. For example, in a group analysis approach, the at least three Mentors may discuss and debate each matrix of consistent existence in such a manner that a comparison of the collective matrix versus the identified inconsistent internal existence transpires. In such an approach, there may be group issue spotting, discussion, arguments, debates, reasons and rationales that are articulated.

In an individual analysis, for example, each individual Mentor of the at least three Mentors may individually issue spot, progress through the comparison, reason, and synthesize rationales for their conclusions in their comparison of the identified inconsistent internal existence to the matrix of consistent existence. In such an individual analysis manner, none of the ideas or issues that may be spotted by any one of the at least three Mentors will be selectively abandoned by based on the group valuation of the idea or issue. That is, the process of comparison may be individually completed by each Mentor, for example, in order to pursue the unique perspectives of individuals.

A combination thereof may refer to an individual analysis followed by a group analysis, a group analysis followed by an individual analysis, a series of iterations between group and individual analysis (within a single iteration of the method), or a hybrid approach. In the hybrid approach, for example, at least two of the at least three Mentors may be engaged in a group of analysis, while at least one of the at least three Mentors may be engaged in an individual analysis. Additionally, it should be noted that in a hybrid group analysis that may have more than three Mentors, there may be two or more groups made up of at least two Mentors each that may complete a group analysis hybrid.

After the comparison is completed by the at least three Mentors, the method for blindly resolving an issue 200 comprises the step of (f) providing feedback to the Focus from the at least three Mentors 260. Providing feedback to the Focus may comprise publishing at least one instructed action to the Focus based on the comparison completed by the at least three Mentors of the group. Publishing may refer to any oral, audio, visual, or written communication that is presented to a Focus by or on behalf of the at least three Mentors. An instructed action may include suggestions, advice, guidelines, actions, instructions, goals, commands, mandates, scheduling, or training for the Focus to enact, participate in, undergo, or otherwise complete. Also, the at least three Mentors may indicate or otherwise correlate the at least one instructed action to a period of time for completion, termed a preselected post feedback period of time.

After the at least one instructed action is presented to a Focus by or on behalf of the at least three Mentors, the method for blindly resolving an issue 200 comprises the step of (g) incorporating the feedback by the Focus to create a modified internal existence of the Focus 270. Incorporating the feedback by the Focus to create a modified internal existence may be, for example, completing the at least one instructed action within at least one preselected post feedback time period. A preselected post feedback period of time may be, for example, an hour, a day, a week, a month, a year, five years, a decade, or a lifetime. Further, a preselected post feedback period of time may include, for example, that at least one instructed action be completed every prescribed cycle, for each prescribed cycle in a preselected post feedback period. As an illustrative example, a Focus may incorporate the feedback from the at least three Mentors by completing the at least one instructed action a week, for a period of three months. A modified internal existence may comprise a resulting behavior pattern or idea of the Focus in at least one subject area after incorporating the feedback of the at least three Mentors of the group.

In an atmosphere in which a member of an organization has an inconsistent internal existence in an addictions/compulsions subject area, the member may implement the method of blindly resolving an issue, in which that member may be the Focus of a group. By employing the method of blindly resolving an issue, the at least three Mentors may blindly evaluate a Focus, identify a Focus' inconsistent internal existence, compare that inconsistent internal existence to a matrix of consistent internal existence, provide feedback to the Focus, and allow the Focus to incorporate the feedback provided, all while maintaining anonymity. Therefore, the method of blindly resolving an issue with respect to an addiction to violence would preserve the confidentiality of the Focus identity and also circumvent prejudices that may otherwise be unknowingly asserted against the Focus. The resolution of a violence addiction may reduce, eliminate, or otherwise eradicate criminal conduct by the Focus, where a blind method of resolving an issue will preserve the Focus privacy, allowing the Focus to be completely candid in his disclosure of information to the at least three Mentors. The method for blindly resolving issues may be incorporated into any organization in order to facilitate the resolution of violence addictions among its members.

A group may be provided, wherein the group includes at least three Mentors and a Focus. In this group, the group members may be composed of members of an organization. The members may be of any rank within the organization.

After the group is provided, the group may be blinded, wherein the at least three Mentors are blind as to the Focus. Blinding a group also may comprise implementing a communication formatting system, as previously discussed. The communication formatting system may comprise a blind exchange apparatus and operation standards for communication. One or more of the blind exchange apparatus' and operation standards may be implemented into an organization's communication formatting system for the method of blindly resolving an issue.

After the group has been blinded, the at least three Mentors may evaluate the Focus. In order to determine if a Focus may be addicted to violent behaviors, the at least three Mentors may evaluate the Focus by processing Focus information. The Focus information may be related to the violent actions and criminal conduct area, and more particularly, may include the Focus disclosures which may indicate the Focus' own perception of their violent tendencies and actions against others. The Focus information may be disclosed to the at least three Mentors through the communication formatting system. Also, the Focus information may include factual disclosures about previous actions, details about the victims of violent acts, behavior patterns, upbringing, timelines of conduct, or frequency of conduct, all of which may be used as an illustrative example of how the Focus may act in violence, patterns of violence, and identifying characteristics of those targeted. The at least three Mentors may process such information in order to evaluate the Focus in the addictions/compulsions subject area related to an addiction to violent acts.

After the at least three Mentors evaluate the Focus based on the Focus information, the at least three Mentors may identify an inconsistent internal existence of the Focus' violent acts. For example, after evaluating information relating to the Focus' perception of their violent tendencies, the detailed factual descriptions of the violent actions, identification of the characteristics or relationship to the Focus of those that were acted against, the at least three Mentors may be able to identify at least one internal inconsistent existence of the Focus.

For example, a Focus may disclose a history of spousal abuse, as the Focus may admit to beating his wife. Here, the at least three Mentors may identify one or more inconsistent internal existence in the Focus. Examples of inconsistent internal existences of a Focus with a history of spousal abuse may include poor communication skills and improper anger management.

After the at least three Mentors have identified an inconsistent internal existence of the Focus, the at least three Mentors may compare the inconsistent internal existence to a matrix of consistent internal existence by the at least three Mentors. A consistent internal existence may be a behavior pattern or belief that is considered rational for an individual or computer database to exhibit and articulate based upon a comparison between their own understanding, experience, and reality. A matrix of consistent internal existence of a Mentor may comprise a set, body, or collection of ideas, patterns, behaviors, views, topics, data, or positions of the Mentor. In this example, a matrix of consistent internal existence may also comprise the organization's guidelines, the relevant laws relating to the Focus' activities, training manuals, counseling materials, past experiences of the at least three Mentors in an area of addictions/compulsions, and any other documents relating to violence, communication, anger management, or specifically, spousal abuse. In the comparison, each of the at least three Mentors analyzes the Focus information in context against each Mentor's matrix of consistent internal existence within a managerial skills area. The matrix of consistent internal existence for the addictions/compulsions area relating to spousal abuse of the at least three Mentors may contain: factual knowledge about violence, abuse, communication, anger management, or spousal abuse; past experiences relating to violence, abuse, communication, anger management, or spousal abuse; acquired information which may be the product of reading or learning in the area of violence, abuse, communication, anger management, or spousal abuse; and best methods and practices to conform to the a lifestyle free from violence, abuse, ineffective or non-existent communication, improper anger management, or spousal abuse; and any published information that details the practices and methodology behind counseling individuals with respect to violence, abuse, communication, anger management, or spousal abuse. As previously discussed, the at least three Mentors of a group may analyze the Focus information against their matrices of consistent internal existence by group analysis, individual analysis, or combinations thereof.

After the comparison, which may be done by at least three Mentors, the at least three Mentors provide feedback to the Focus. Providing feedback to the Focus may be done by publishing at least one instructed action to the Focus as a result of the comparison. As previously stated, publishing may refer to any oral, audio, visual, or written communication that is presented to a Focus by or on behalf of the at least three Mentors. Again, publishing the at least one instructed action to the Focus may be done through the communication formatting system so that the method may remain blinded and anonymous. In an addictions/compulsions area specifically dealing with spousal abuse, the at least one instructed action published to a Focus may be an anger management exercise in which the Focus is presented with a detailed description of completion. As another example, the at least one instructed action may be for the Focus to read several published books on overcoming violence and violent behaviors and to come up with at least one action item to implement based on their readings. As still another example, the at least one instructed action may be that the Focus enroll in a course in communicating and articulating his feelings, ideas, or opinions to others in an effective way. As still yet another example, the at least one instructed action may be for the Focus to acquire a therapist so that a professional may discuss, explore, and counsel the Focus in his addiction or compulsion of spousal abuse.

After the Focus has received the feedback from the at least three Mentors, the Focus may incorporate the feedback such that the Focus may create a modified internal existence. A Focus may incorporate the feedback by completing the at least one instructed action within a preselected post feedback time period. For example, a Focus may complete the at least one instructed action by completing an anger management exercise; reading one or more books on overcoming violence and violent behaviors and completely implement their action item; enrolling in a course on successfully communicating with others; or acquiring a therapist and attending several sessions, where each of the aforementioned is completed within the preselected post feedback period of time. Further, completion of the at least one instructed action may be communicated to the at least three Mentors of the group through the communication formatting system. At the completion of the at least one instructed action, the Focus may create a modified internal existence. That is, the Focus has created a resulting behavior pattern or idea in the addictions/compulsion subject area, specifically relating to spousal abuse. For example, after completing an anger management exercise within a preselected post feedback period of time, a Focus may deal with anger and frustration in a more communicative, less abusive way. As another example, after reading one or more books on overcoming violence and violent behaviors and completely implementing their own action item, the Focus may learn about the effects of their actions more thoroughly and incorporate into their lives measurable goals or actions that they complete on a periodic basis. As another example, after enrolling in a course on successfully communicating with others, the Focus may be able to effectively communicate their feelings to others and their anger or frustration may be orally expressed, and not physically acted out upon others. As a final example, after acquiring a therapist and attending several sessions, the Focus may be counseled to reduce or eliminate their violent acts and abusive tendencies.

The resulting modified internal existence may be measured and verified in the same ways that the Focus was evaluated, through the gathering and processing of Focus information. Similarly, Focus's modified internal existence that is created through completing the at least one instructed action within a preselected post feedback period of time may be measured and verified. That is, the Focus disclosures of Focus information may be gathered and evaluated such that the modified internal existence may be gauged.

A modified internal existence may, but need not, be a change from an inconsistent internal existence to a consistent internal existence, consistent with that of the at least three Mentor's matrix of internal existence. That is, upon completing the method, the method may be reiterated until the modified internal existence may no longer be identified by the at least three Mentors as an inconsistent internal existence.

FIG. 6 illustrates a flow chart of a method for resolving an issue blindly with reiteration. The method, as articulated inter alia, may further comprise the step of reiterating steps (b) 220 through (g) 270 until the step of (d) identifying the inconsistent internal existence of a Focus 240 step yields no identifiable inconsistent internal existence. That is, the at least three Mentors, after the evaluating the Focus, may be unable to detect a Focus' inconsistent internal existence from the Focus information, and may thereby halt the method. The method may be reiterated, for example: once, twice, or many times until an inconsistent internal existence is no longer identified by the at least three Mentors.

Alternatively, it should be noted that there may be a fail safe step incorporated into the method in order to prevent the method from running in an infinite loop. For example, if the Focus does not, cannot, or otherwise refuses to properly incorporate the feedback from the at least three Mentors, then the Focus may not be said to realize a modified internal existence as a result of the process. Therefore, in the previous example, it may not matter the number of times the method is reiterated. If method steps are incomplete due to a non-compliant Focus, repeating the method may not show progress or beneficial results and may be ceased. Additionally, if the reiteration of the method becomes a burden to the time, resources, or efficiency of the at least three Mentors or the Focus, the method may be ceased. In such rare examples, the Focus may be recommended to one or more areas outside of the method, including but not limited to: disciplinary action, outside counseling (including diversity training, psychology sessions, psychiatry sessions, or other therapy sessions), reporting to law enforcement, legal, or administrative authorities, substance abuse rehabilitation, medical intervention, or mental health facilities.

The step of reiterating steps (b) through (g) until the step of (d) identifying the inconsistent internal existence of a Focus no longer yields an identifiable inconsistent internal existence may further comprise providing a plurality of groups to the method for blindly resolving an issue. That is, a previous group may be transformed into a subsequent group through a series of processes so that the method may be reiterated with one or more groups.

Referring to FIG. 7, a flow chart is depicted that illustrates a method for resolving an issue blindly with reiteration using a plurality of groups. A plurality of groups as used herein is a gathering of two or more groups which may facilitate, for example, the reiteration of the method from steps (b) through (g). Examples of a plurality of groups include, but may not be limited to: a conference with fifty attendees organized into two groups of twenty five members; a classroom of twenty individuals organized into five groups of four members; a discussion group of thirty people organized into six groups of five members; or a computer database or a plurality of computer databases which may simulate such groupings.

In the plurality of groups, each group may include at least three Mentors and a Focus, further wherein after steps (b) 220 through (g) 270 may be completed in a previous group, the previous group may be transformed into a subsequent group 290, and steps (b) 220 through (g) 270 may be subsequently reiterated 280 in a subsequent group. Through one or more processes, the previous group may be transformed into the subsequent group 290.

FIG. 8 shows the step of transforming a previous group into a subsequent group 290. Prior to reiterating the method as articulated in steps (b) 220 through (g) 270 a previous group is transformed into a subsequent group 290 by performing at least one process. The transforming process may be any one of a number of potential operations or combinations of operations, including, for example: adding at least one subsequent Mentor 221; deleting at least one previous Mentor 222; replacing at least one previous Mentor with at least one subsequent Mentor while maintaining the previous Focus 223; replacing the previous Focus with a subsequent Focus while maintaining the previous at least three Mentors 224; switching the previous Focus and one of the at least three previous Mentors from the previous group such that they are the subsequent Mentor and subsequent Focus, respectively, of a subsequent group 229; changing the previous Focus into a subsequent Mentor and adding a subsequent Focus 225; changing the previous Mentor into a subsequent Focus and deleting the previous Focus 226; doing nothing 227; and a combination thereof 228. Further, once the at least one operation may be completed, the subsequent group may have at least three Mentors and one Focus. Next, each of the transforming processes will be discussed.

Adding at least one subsequent Mentor 221 may include, for example, adding one subsequent Mentor, two subsequent Mentors, or many subsequent Mentors so that the previous group may be transformed into the subsequent group.

Deleting at least one previous Mentor 222 may include, for example, deleting one previous Mentor, two previous Mentors, many previous Mentors, or all previous Mentors so that the previous group may be transformed into the subsequent group.

Replacing at least one previous Mentor with at least one subsequent Mentor while maintaining the previous Focus 223 may include, for example, replacing one, two, many, or all of the previous Mentors with subsequent Mentors so that the previous group may be transformed into the subsequent group.

Replacing the previous Focus with a subsequent Focus while maintaining the previous at least three Mentors 224 may comprise replacing the Focus for the subsequent group while maintaining the at least three Mentors so that the previous group may be transformed into the subsequent group.

Switching the previous Focus and one of the at least three previous Mentors from the previous group such that they are the subsequent Mentor and subsequent Focus of a subsequent group 229, respectively, may be a process of transformation from a previous group into a subsequent group may transform the previous group into the subsequent group. That is, because the group has been blinded in step (b) 230 (as shown in FIG. 7), a previous Focus and a previous Mentor may switch roles during the process, and the method for resolving issues blindly may not be detrimentally affected in the ways previously discussed under the non-blinded method for resolving issues.

Changing the previous Focus into a subsequent Mentor and adding a subsequent Focus 225 may transform a previous group into a subsequent group.

Changing the previous Mentor into a subsequent Focus and deleting the previous Focus 226 may transform a previous group into a subsequent group.

A previous group may be transformed into a subsequent group by doing nothing 127. Doing nothing is illustrated in FIG. 8 by not performing any of the operations listed in FIG. 8 This may be essentially following the path of “NO” as illustrated in FIG. 8. In other words, operation 221, 222, 223, 224, 229, 225, and 226 were not performed on the previous group in order to transform it into the subsequent group. In this case, the method for blindly resolving an issue may be reiterating with the same members in the same roles, but that the members of the group may now be termed a subsequent group.

Further, combinations of adding, deleting, changing, switching, replacing, and doing nothing as previously articulated may be performed in order to transform a previous group into a subsequent group 290. Referring to FIG. 8, at each operation query for 221, 222, 223, 224, 229, 225, and 226, the operation may either be performed or not. This may be shown by the listing of YES/NO after each operation listing in FIG. 8.

At the completion of one or more operations, the previous group provided 111 may become provided as a subsequent group 112 for the method of blindly resolving an issue. It should be noted that at the end of transforming a previous group into a subsequent group 290, the subsequent group may still conform to the aforementioned guideline of containing a Focus and at least three Mentors in the group.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for resolving an issue, comprising:
providing a group, wherein the group includes at least three Mentors and a Focus;
evaluating the Focus by the at least three Mentors;
identifying an inconsistent internal existence of the Focus by the at least three Mentors;
comparing the inconsistent internal existence to a matrix of consistent internal existence by the at least three Mentors;
providing feedback to the Focus from the Mentors; and
incorporating the feedback by the Focus to create a modified internal existence of the Focus.

2. The method of claim 1, wherein the inconsistent internal existence comprises an irrational behavior pattern or irrational idea of the Focus.

3. The method of claim 1, wherein the matrix of consistent internal existence comprises at least one Mentor's factual knowledge, past experiences, and acquired information on at least one subject.

4. The method of claim 1, wherein the modified internal existence comprises a resulting behavior pattern of the Focus after incorporating the feedback of the at least three Mentors of the group.

5. The method of claim 1, wherein providing feedback to the Focus comprises publishing at least one instructed action to the Focus based on the comparison completed by the at least three Mentors of the group.

6. The method of claim 1, wherein incorporating the feedback by the Focus to create a modified internal existence comprises completing the at least one instructed action within at least one preselected post feedback time period.

7. The method of claim 1, further comprising the step of reiterating steps (b) through (f) until (c) identifying the inconsistent internal existence of a Focus yields no identifiable inconsistent internal existence.

8. The method of claim 7, further comprising providing a plurality of groups, wherein each group includes at least three Mentors and a Focus, further wherein after steps (b) through (f) are completed in a previous group, steps (b) through (f) are subsequently reiterated in a subsequent group of the plurality of groups.

9. The method of claim 8, wherein the previous group is transformed into the subsequent group by performing at least one process selected from a group consisting of:
adding at least one subsequent Mentor;
deleting at least one previous Mentor;
replacing the at least one previous Mentor with the at least one subsequent Mentor while maintaining a previous Focus;
replacing the previous Focus with a subsequent Focus while maintaining a previous at least three Mentors;
changing the previous Focus into the subsequent Mentor and adding the subsequent Focus;
changing the previous Mentor into the subsequent Focus and deleting the previous Focus;
doing nothing; and
a combination thereof, in which at the conclusion of the at least one process, the subsequent group comprises the at least three Mentors and one Focus.

10. The method of claim 9, wherein the previous Focus is not the subsequent Mentor for the previous Mentor that is the subsequent Focus.

11. The method of claim 9, wherein the previous Mentor is not the subsequent Focus for the previous Focus that is the subsequent Mentor.

12. A method for blindly resolving an issue, comprising:
providing a group, wherein the group includes at least three Mentors and a Focus;
blinding the group, wherein the at least three Mentors are blind as to the Focus;
evaluating the Focus by the at least three Mentors;
identifying an inconsistent internal existence of the Focus by the at least three Mentors;
comparing the inconsistent internal existence to a matrix of consistent internal existence by the at least three Mentors;
providing feedback to the Focus from the Mentors; and
incorporating the feedback by the Focus to create a modified internal existence.

13. The method of claim 12, wherein blinding the group comprises implementing a communication formatting system.

14. The method of claim 13, wherein the communication formatting system comprises a blind exchange apparatus and at least one operation standard.

15. The method of claim 12, wherein evaluating the Focus by the at least three Mentors comprises processing Focus information of the Focus.

16. The method of claim 12, wherein identifying an inconsistent internal existence of the Focus by the at least three Mentors comprises detecting the Focus's inconsistent internal existence from the Focus information.

17. The method of claim 12, wherein comparing the inconsistent internal existence of the Focus to a matrix of consistent internal existence by the at least three Mentors comprises an analysis selected from one of the group consisting of: a group analysis, an individual analysis, or combinations thereof.

18. The method of claim 12, further comprising the step of reiterating steps (b) through (g) until (d) identifying the inconsistent internal existence of a Focus yields no identifiable inconsistent internal existence.

19. The method of claim 18, further comprising providing a plurality of groups, wherein each group includes the at least three Mentors and a Focus, further wherein after steps (b) through (g) are completed in a previous group, steps (b) through (g) are subsequently reiterated in a subsequent group of the plurality of groups.

20. The method of claim 19, wherein the previous group is transformed into the subsequent group by performing at least one process selected from a group consisting of:
adding at least one subsequent Mentor;
deleting at least one previous Mentor;
replacing the at least one previous Mentor with the at least one subsequent Mentor while maintaining a previous Focus;
replacing the previous Focus with a subsequent Focus while maintaining a previous at least three Mentors;
switching the previous Focus and a previous Mentor to the subsequent Mentor and the subsequent Focus;
changing the previous Focus into the subsequent Mentor and adding the subsequent Focus;
changing the previous Mentor into the subsequent Focus and deleting the previous Focus;
doing nothing; and
a combination thereof, in which at the conclusion of the at least one process, the subsequent group comprises the at least three Mentors and one Focus.
